(19) United States
(12) Patent Application Publication
(10) Pub. No.: US 2023/0300753 A1
(43) Pub. Date: Sep. 21, 2023

(54) ELECTRONIC DEVICE AND OPERATING METHOD THEREFOR

(71) Applicant: SAMSUNG ELECTRONICS CO., LTD., Suwon-si (KR)

(72) Inventors: Changlae Jo, Suwon-si (KR); Ankit Dhanuka, Suwon-si (KR); Deoknam Kim, Suwon-si (KR)

(73) Assignee: SAMSUNG ELECTRONICS CO., LTD., Suwon-si (KR)

(21) Appl. No.: 18/197,966

(22) Filed: May 16, 2023

Related U.S. Application Data
(63) Continuation of application No. PCT/KR2021/017009, filed on Nov. 18, 2021.

(30) Foreign Application Priority Data
Nov. 18, 2020 (KR) 10-2020-0154543

(51) Int. Cl. H04W 52/02; H04W 36/08; H04W 36/38

(52) U.S. Cl. CPC H04W 52/0235; H04W 36/08; H04W 36/38; H04W 84/12

(57) ABSTRACT

The present disclosure provides methods and electronic devices for accessing an access point. In some embodiments, the electronic device includes a Wi-Fi module including an internal memory, and a processor configured to execute at least one instruction. The Wi-Fi module is configured to store, in the internal memory, a first request requesting an access point transition. The Wi-Fi module is further configured to generate a wakeup signal, based on reception of the first request from a first access point, while the processor is in a suspend mode. The Wi-Fi module is further configured to transmit, to the processor, the first request stored in the internal memory, after the processor has woken up based on the wakeup signal.

### CROSS-REFERENCE TO RELATED APPLICATIONS

This application is a continuation application of International Application No. PCT/KR2021/017009, filed on Nov. 18, 2021, which claims priority to Korean Patent Application 10-2020-0154543, filed on Nov. 18, 2020, in the Korean Intellectual Property Office, the disclosures of which are incorporated by reference herein in their entireties.

### BACKGROUND

### 1. Field

The present disclosure relates generally to wireless communications, and more particularly, to an electronic device accessing an access point (AP) to access a Wireless-Fidelity (Wi-Fi) network, and an operating method thereof.

### 2. Description of Related Art

According to related technologies, an electronic device and another electronic device may be connected to each other through a wireless communication network, and a plurality of connected electronic devices may be used by interworking with each other. For example, the plurality of electronic devices connected to each other through the wireless communication network may include, but not be limited to, a display device (e.g., a television (TV)), a smartphone, a personal computer (PC), a personal digital assistant (PDA), a remote controller, a vehicle, a smart appliance (e.g., a refrigerator, a washing machine), and a wearable device (e.g., a smart watch). Alternatively or additionally, the plurality of electronic devices may include a server and/or a server device.

A representative example of the wireless communication network may include a wireless local area network (WLAN) in which a network is constructed by using radio waves. WLAN may also be referred to as a wireless LAN, and/or may be used in the same sense as Wi-Fi.

For the plurality of electronic devices to be connected to each other through Wi-Fi, each of the plurality of electronic devices may need to access an access point. The access point may include a device that transmits and/or receives wireless data to and/or from each of the plurality of electronic devices and transmits the transmitted/received wireless data to a wired network through an Ethernet port. The access point may also be referred to as a wired/wireless router.

For the plurality of electronic devices to seamlessly communicate with each other, the access point may need to seamlessly transmit and/or receive data. For example, the plurality of electronic devices may not seamlessly communicate with each other when the amount of data being transmitted/received at the access point is large and/or the access point is unable to be used.

Accordingly, there is a need for a method and apparatus for the plurality of electronic devices to seamlessly communicate with each other by using the wireless communication network.

### SUMMARY

Aspects of the present disclosure provide an electronic device and an operating method thereof, wherein a plurality of electronic devices may seamlessly communicate with each other by using a wireless communication network.

More particularly, embodiments provide an electronic device and an operating method thereof, wherein, even when an electronic device accessing a wireless communication network is in a suspend mode, the electronic device may maintain a state of seamlessly communicating with another electronic device.

According to an aspect of the present disclosure, an electronic device is provided. The electronic device includes a Wi-Fi module including an internal memory, and a processor configured to execute at least one instruction. The Wi-Fi module is configured to store, in the internal memory, a first request requesting an access point transition. The Wi-Fi module is further configured to generate a wakeup signal, based on reception of the first request from a first access point, while the processor is in a suspend mode. The Wi-Fi module is further configured to transmit, to the processor, the first request stored in the internal memory, after the processor has woken up based on the wakeup signal.

In some embodiments, the processor may be further configured to execute the at least one instruction to control the Wi-Fi module to transmit, to the first access point, a first response, based on the first request.

In some embodiments, the electronic device may further include a microcomputer configured to receive the wakeup signal transmitted from the Wi-Fi module, and transmit a power-on signal to the processor, based on the wakeup signal. The processor may be further configured to execute the at least one instruction to wake up based on reception of the power-on signal.

In some embodiments, the first request may include a basic service set (BSS) transition management (BTM) request.

In some embodiments, the electronic device may be further configured to identify whether the processor has woken up when a predetermined time duration has elapsed after transmission of the wakeup signal, and transmit, to the processor, the first request stored in the internal memory, based on a result of the identifying that the processor has woken up.

In some embodiments, the electronic device may be further configured to transmit, to the processor, the first request stored in the internal memory, based on reception of an up signal indicating that the processor has woken up.

In some embodiments, the processor may be further configured to execute the at least one instruction to control an access point, accessed by the Wi-Fi module, to transition from the first access point to a second access point when the first response is transmitted to the first access point.

In some embodiments, the processor may be further configured to execute the at least one instruction to execute the at least one instruction to enter the suspend mode when the transition of the access point has been completed.

In some embodiments, the processor may be further configured to execute the at least one instruction to transmit, to the Wi-Fi module, a command instructing to maintain a connection with the second access point, and transmit, to the Wi-Fi module, a notification indicating entry to the suspend mode, based on the transition of the access point having been completed.

In some embodiments, the electronic device may be further configured to maintain access to an Internet of Things (IoT) server while the processor is in the suspend mode.

In some embodiments, the electronic device may further include a wireless client device connected with a mesh network formed by a plurality of access points.

According to an aspect of the present disclosure, an operating method of an electronic device is provided. The operating method includes receiving, from a first access point, a first request requesting an access point transition, while the electronic device is in a suspend mode. The operating method further includes storing the first request in an internal memory. The operating method further includes generating a wakeup signal. The operating method further includes transmitting, to a processor of the electronic device, the first request stored in the internal memory after the processor has woken up based on the wakeup signal.

In some embodiments, the operating method may further include transmitting, to the first access point, a first response, based on the first request.

In some embodiments, the transmitting of the first request may include identifying whether the processor has woken up when a predetermined time duration has elapsed after the wakeup signal has been transmitted, and transmitting, to the processor, the first request stored in the internal memory, based on a result of the identifying.

In some embodiments, the operating method may further include controlling a third access point to transition from the first access point to a second access point, when the first response has been transmitted to the first access point.

In some embodiments, the first request may include a BTM request.

In some embodiments, a microcomputer is comprised in the electronic device, and the method further comprising, by the microcomputer, receiving the wakeup signal, and transmitting a power-on signal to the processor, based on the wakeup signal; and the processor is wakening up based on reception of the power-on signal.

In some embodiments, the operating method further comprising by the processor, transmitting a command instructing to maintain a connection with the second access point and a notification indicating entry to the suspend mode, based on the transition of the access point having been completed; and entering the suspend mode.

In an electronic device and an operating method of the electronic device, according to embodiments, when the electronic device is accessing a Wireless Fidelity (Wi-Fi) network by an IoT platform, an access point transition operation for maintaining high communication quality may be performed even when the electronic device is in a suspend mode, and thus a high communication quality may be maintained. Accordingly, the electronic device may implement an IoT environment with a high degree of reliability.

Additional aspects are set forth in part in the description which follows and, in part, are to be apparent from the description, and/or may be learned by practice of the presented embodiments.

### BRIEF DESCRIPTION OF THE DRAWINGS

The above and other aspects, features, and advantages of certain embodiments of the present disclosure are to be more apparent from the following description taken in conjunction with the accompanying drawings, in which:

FIG. 1 is a diagram describing an electronic device accessing a wireless communication network, according to an embodiment;

FIG. 2 is a diagram describing an electronic device in a suspend mode accessing a wireless communication network, according to an embodiment;

FIG. 3A is a block diagram of an electronic device, according to an embodiment;

FIG. 3B is a block diagram of an electronic device, according to an embodiment;

FIG. 4 is a block diagram of an electronic device, according to an embodiment;

FIG. 5A is a flowchart of an operating method of an electronic device, according to an embodiment;

FIG. 5B is a flowchart of an operating method of an electronic device, according to an embodiment;

FIG. 6 is a diagram describing an operating method of an electronic device, according to an embodiment;

FIG. 7 is a diagram describing an operation of identifying wakeup of a processor in an operating method of an electronic device, according to an embodiment;

FIG. 8 is a diagram describing an operating method of an electronic device, according to an embodiment;

FIG. 9 is a block diagram of an electronic device, according to an embodiment;

FIG. 10 is a diagram describing an operating method of an electronic device, according to an embodiment;

FIG. 11 is a diagram describing transition of an access point accessed by an electronic device in a suspend mode, according to an embodiment;

FIG. 12 is a diagram describing an example of using an electronic device, according to an embodiment; and

FIG. 13 is a diagram describing an electronic device which operates in an Internet of Things (IoT) environment, according to an embodiment.

### DETAILED DESCRIPTION

Hereinafter, embodiments of the present disclosure are described in detail with reference to the accompanying drawings such that one of ordinary skill in the art may implement the present disclosure. However, the present disclosure may be implemented in various different forms and is not limited to embodiments described herein. Also, in the drawings, parts not needed for the description may be omitted in order to clearly describe the present disclosure. Like reference numerals may designate like elements throughout the disclosure.

Throughout the disclosure, when a part is “connected” to another part, the part may not only be “directly connected” to the other part, but may also be “electrically connected” to the other part with another element in between. In addition, when a part “includes” a certain element, the part may further include another element instead of excluding the other element, unless otherwise stated.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment.

Some embodiments may be represented by functional block configurations and various processing operations. Some or all of these functional blocks may be implemented by various numbers of hardware and/or software configurations that perform particular functions. For example, the functional blocks of the present disclosure may be implemented by one or more processors or microprocessors or by circuit configurations for performing an intended function. Also, for example, the functional blocks of the present disclosure may be implemented in various programming or scripting languages. The functional blocks may be implemented by algorithms executed in one or more processors. In addition, the present disclosure may employ general techniques for electronic environment setting, signal processing, and/or data processing. Terms such as modules and configurations may be widely used and are not limited to mechanical and physical configurations.

In addition, a connection line or a connection member between components shown in drawings is merely a functional connection and/or a physical or circuit connection. In an actual device, connections between components may be represented by various functional connections, physical connections, or circuit connections that are replaceable or added.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

An electronic device, according to an embodiment, may include an electronic device connectable to another electronic device via a wireless communication network.

For example, an electronic device, according to an embodiment, may be implemented in various forms such as, but not limited to, a television (TV), a digital TV, a mobile phone, a tablet personal computer (PC), a digital camera, a camcorder, a laptop computer, a desktop computer, an electronic book terminal, a digital broadcasting terminal, a personal digital assistant (PDA), a portable multimedia player (PMP), a navigation device, an MPEG-1 Audio Layer 3 (MP3) player, a wearable device, and a watch. Alternatively or additionally, an electronic device, according to an embodiment, may include a household appliance such as a refrigerator, an air purifier, a washing machine, or a drying machine. In an embodiment, an electronic device may include a fixed electronic device arranged at a fixed location and/or a mobile electronic device in a portable form. In an optional or additional embodiment, an electronic device may include a digital broadcast receiver capable of receiving a digital broadcast.

Hereinafter, an electronic device, according to an embodiment, is described and illustrated as an example of a display device (e.g., a TV) that may include a display to visually output image data.

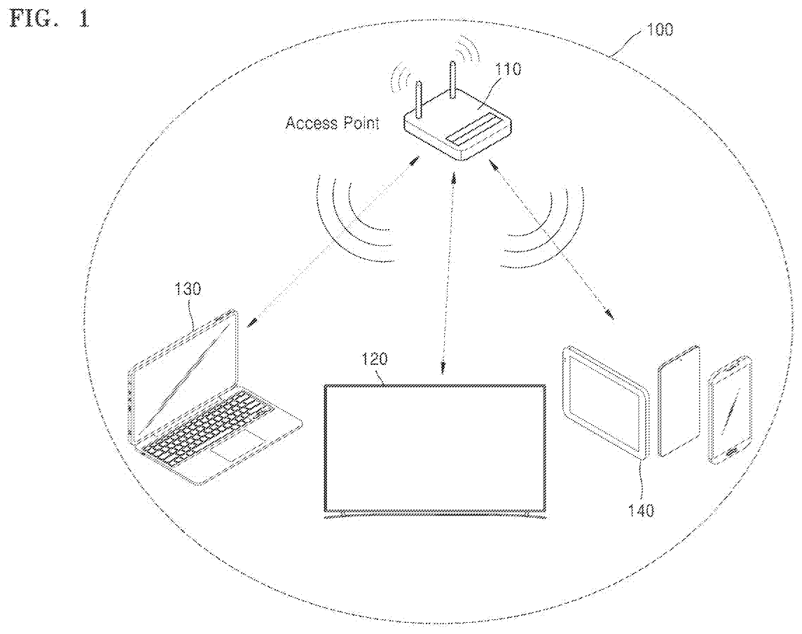

FIG. 1 is a diagram describing an electronic device accessing a wireless communication network, according to an embodiment.

Referring to FIG. 1, the electronic device accessible to the wireless communication network may include a laptop computer 130, a TV 120, or a mobile device 140. Hereinafter, including FIG. 1, an example in which the electronic device according to an embodiment is a TV is described.

The electronic device 120 may access the wireless communication network and/or may transmit/receive data to/from another electronic device through the wireless communication network. The other electronic device connected to the electronic device 120 may include, like the electronic device 120 described above, a mobile phone, a tablet PC, a digital camera, a camcorder, a laptop computer, a desktop computer, an electronic book terminal, a digital broadcasting terminal, a PDA, a PMP, a navigation device, an MP3 player, a wearable device, a refrigerator, a washing machine, a drying machine, or an air purifier. Alternatively or additionally, the other electronic device connected to the electronic device 120 may include a fixed electronic device arranged at a fixed location or a mobile electronic device in a portable form, and/or may include a digital broadcast receiver capable of receiving a digital broadcast. In an embodiment, the other electronic device connected to the electronic device 120 through the wireless communication network may include a server and/or a server device.

The wireless communication network accessed by the electronic device 120 may be a wireless local area network (WLAN). The WLAN may also be referred to as Wireless Fidelity (Wi-Fi or Institute of Electrical and Electronics Engineers (IEEE) 802.11x). Hereinafter, the wireless communication network may be referred to as Wi-Fi for convenience of description.

Referring to FIG. 1, a region 100 may indicate a basic service set (BSS) that is a basic component forming a Wi-Fi network. An access point (AP) 110 may be present in the region 100.

The AP 110 may include a device operating as a bridge between the wireless communication network and a wired communication network. For example, the AP 110 may operate as a base station in a WLAN and connect a wired network and a wireless network to each other. Alternatively or additionally, the AP 110 may operate as a bridge connecting the WLAN to which at least one of the electronic devices 120, 130, and 140 is connected and a mobile communication network connected to an external electronic device (e.g., a server, an Internet of things (IoT) server, a cloud server) to each other.

In FIG. 1, the wired communication network may include a communication network for the AP 110 to be connected to a distribution station (DS). Alternatively or additionally, the wireless communication network may include a communication network formed within the region 100 of FIG. 1, and/or at least one of the electronic devices 120, 130, and 140 may transmit/receive data through the wireless communication network by accessing the AP 110. In an embodiment, an electronic device (e.g., the electronic device 120) accessing the AP 110 may be referred to as a client device and/or a station.

When the electronic device 120 is a display device, such as a TV, the display device may maintain an access to the AP 110 not only in a normal driving state, (e.g., a state in which certain content is being reproduced through a display), but also in a suspend state in which a black screen is output through the display without reproducing content. Accordingly, the electronic device 120 may constantly maintain an access to the Wi-Fi network through the AP 110.

Hereinafter, a working mode according to a driving state of the electronic device 120 is first described.

The working mode in which power is supplied to a plurality of components included in the electronic device 120 for normal operation may be referred to as an active mode and/or a normal mode. Alternatively or additionally, a working mode in which power is turned on or off in the plurality of components included in the electronic device 120 or power is supplied to the least components required to maintain essential communication may be referred to as a suspend mode (or standby mode) or a sleep mode.

When the electronic device 120 is a display device, such as a TV, a working mode of the display device may largely include a normal mode and a suspend mode. In an embodiment, the normal mode may also be referred to as a normal working mode. For example, the normal mode and the suspend mode may be distinguished based on whether power is supplied to at least one component other than a communication module (or a communicator). That is, the normal mode may denote a working state in which power is supplied to the communication module and at least one component of the display device. Alternatively or additionally, the suspend mode may denote a working state in which power is supplied only to the communication module.

Alternatively or additionally, when the communication module does not perform a timer operation (e.g., when a component (e.g., a microcomputer to be described below) other than the communication module performs the timer operation), the suspend mode may denote a working state in which power is supplied only to the communication module and the component (e.g., the microcomputer) performing the timer operation.

In an embodiment, a mode in which power is supplied to the communication module and a processor is woken up by the communication module may be referred to as a low power mode (LPM). When the working mode of the electronic device, (e.g., the display device) is largely distinguished as the normal mode and the suspend mode, the LPM may be included in the suspend mode. Alternatively or additionally, when the working mode is largely distinguished as the normal mode and the suspend mode in terms of the processor, because power is supplied to the processor in the LPM, the LPM may be included in the normal mode in terms of the processor. Alternatively or additionally, a working mode in which power is supplied to the processor woken up by the communication module and power is not supplied to a component other than the processor may be separately referred to as the LPM. For example, the LPM may indicate a state in which the communication module wakes up the processor such that power is supplied to the processor and the processor performs a certain operation but power is not supplied to a display and thus image data may not be output.

For example, in the normal mode, the display device may display a certain image. For another example, in the LPM, the display of the display device may be turned off and thus in a black screen state, but the processor may perform a certain operation.

In an embodiment, the suspend mode may indicate a mode in which only the least power is supplied such that power consumption of the display device may be reduced. The suspend mode may be a mode in which power of the display device may be reduced, and/or may indicate a working state in which power is supplied to the communication module such that a control signal and/or certain data may be transmitted/received to/from an external electronic device.

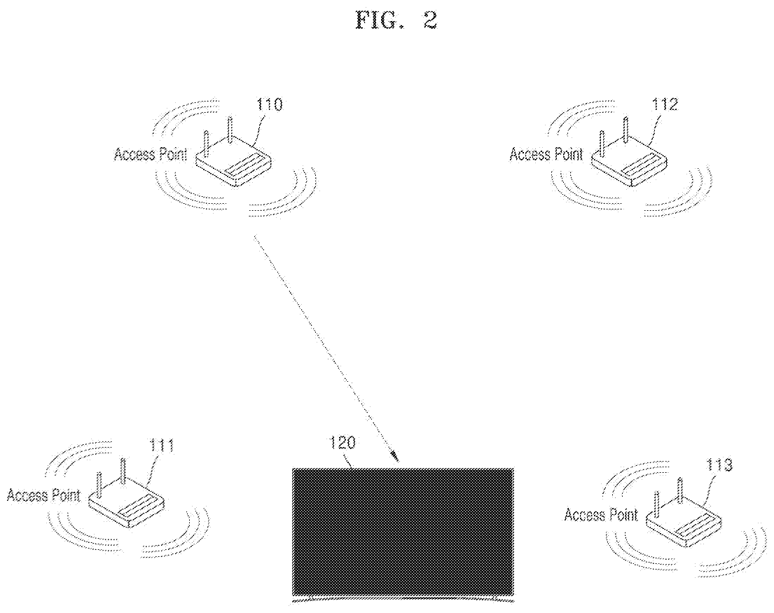

Hereinafter, including FIG. 2, an example in which the electronic device 120 accesses the AP 110 to perform wireless communication is described.

FIG. 2 is a diagram describing an electronic device in a suspend mode accessing a wireless communication network, according to an embodiment.

Referring to FIG. 2, the electronic device 120 may be accessed by the AP 110. Accordingly, the electronic device 120 may access the Wi-Fi network that is a wireless communication network, through the AP 110.

The electronic device 120 may generally maintain access to the Wi-Fi network from another electronic device in the normal mode and in the suspend mode. For example, when the electronic device 120 includes a display device (e.g., a TV) located at a home and is in the suspend mode, a user may want to turn on the electronic device 120 by using their mobile device from outside the home, for example, and record content being reproduced at a current time point. In such an example, the mobile device of the user present at a location spaced apart from a location where the electronic device 120 is located may need to be connected to the electronic device 120 through a communication network. That is, the electronic device 120 may need to access the Wi-Fi network through the AP 110, and the mobile device may also need to be connected to the communication network connected to the AP 110 via wires and/or wirelessly.

Continuing to refer to FIG. 2, the electronic device 120 in the suspend mode may maintain an access to the AP 110.

For the electronic device 120 to seamlessly communicate with another electronic device, a load (e.g., amount) of data transmission/reception of the AP 110 may not need to be high in order to maintain a constant transmission performance.

When the load of the AP 110 is high and/or a low output performance (low throughput) is expected, the electronic device 120 accessing the AP 110 may be unable to seamlessly transmit/receive data to/from the other electronic device by using the Wi-Fi network. When there are other APs (e.g., APs 111, 112, and 113) available to the electronic device 120, the AP 110 may request the electronic device 120 to change (or transition) an AP accessed by the electronic device 120 from the AP 110 to another AP (e.g., the AP 112). When the electronic device 120 is in the normal mode, the electronic device 120 may receive and process such a change request. However, when a related electronic device is in the suspend mode, the related electronic device may be unable to receive and process the change request. For example, a related electronic device in the suspend mode, even when the related electronic device 120 the change request, the related electronic device may be unable to perform a process of transitioning an AP according to the received change request. Thus, a related electronic device may only be able to change an AP when the related electronic device is in the normal mode, and may not be able of changing an AP in the suspend mode such that the related electronic device accesses the Wi-Fi network with a high communication quality.

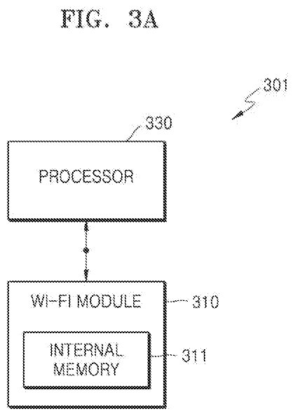

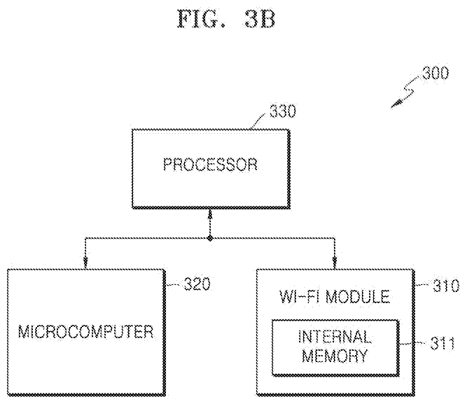

In an embodiment, even when the electronic device 120 is in the suspend mode, a request to change an AP may be received and processed such that the electronic device 120 may access the Wi-Fi network with the high communication quality. An electronic device and an operating method thereof, according to an embodiment, is described with reference to FIGS. 3A to 13.

FIG. 3A is a block diagram of an electronic device, according to an embodiment.

An electronic device 301 shown in FIG. 3A may correspond to an electronic device (e.g., the electronic devices 120, 130, and 140) described with reference to FIGS. 1 and 2. Accordingly, while describing the electronic device 301 according to an embodiment, descriptions that overlap those of FIGS. 1 and 2 may be omitted.

Referring to FIG. 3A, the electronic device 301, according to an embodiment, may include a Wi-Fi module 310 and a processor 330.

For example, the electronic device 301 may include the Wi-Fi module 310 that includes an internal memory 311, and the processor 330 may be configured to execute at least one instruction. When a first request for AP transition is received from a first AP while the processor 330 is in a suspend mode, the Wi-Fi module 310 may store the first request in the internal memory 311 and may generate a wakeup signal. Then, after the processor 330 wakes up based on the wakeup signal, the Wi-Fi module 310 may transmit the first request stored in the internal memory 311 to the processor 330.

Based on being woken up by the wakeup signal and the first request received from the Wi-Fi module 310, the processor 330 may control the Wi-Fi module 310 such that a first response corresponding to the first request to be transmitted to the first AP.

Hereinafter, each component included in the electronic device 301 is described.

The Wi-Fi module 310 may include the internal memory 311. Alternatively or additionally, the Wi-Fi module 310 may perform wireless communication with another electronic device through a Wi-Fi network. For example, the Wi-Fi module 310 may include a communication module for accessing the Wi-Fi network by using a communication method defined in the Wi-Fi communication standard (e.g., IEEE 802.11x).

For example, the Wi-Fi module 310 may perform wireless communication with the other electronic device through the Wi-Fi network, by using an AP. Alternatively or additionally, the Wi-Fi module 310 may perform wireless communication with the other electronic device through the Wi-Fi network, by using a peer-to-peer (P2P) method.

In an embodiment, the Wi-Fi module 310 may control the electronic device 301 to generate the wakeup signal and the processor 330 to wake up based on the generated wakeup signal. For example, even when a working mode of the electronic device 301 is the suspend mode, the Wi-Fi module 310 may receive power and maintain an on-state. In other words, the Wi-Fi module 310 may receive power regardless of the working mode of the electronic device 301. Accordingly, even when the working mode of the electronic device 301 is the suspend mode, the Wi-Fi module 310 may generate the wakeup signal and transmit the generated wakeup signal to the processor 330. Alternatively or additionally, the Wi-Fi module 310 may start an internal timer to count a set time (e.g., a predetermined time duration), and wake the processor 330 up periodically at set time intervals.

The processor 330 may perform at least one instruction to control an intended operation to be performed. In an embodiment, the processor 330 may control overall operations of the electronic device 301. Alternatively or additionally, the processor 330 may control other components included in the electronic device 301 such that a certain operation is performed.

In an embodiment, the processor 330 may include an internal memory and at least one processor configured to execute at least one stored program. In an optional or additional embodiment, the internal memory of the processor 330 may store one or more instructions. Alternatively or additionally, the processor 330 may perform the certain operation by executing at least one of the one or more instructions stored in the internal memory.

In an embodiment, the processor 330 may include a random-access memory (RAM) storing a signal and/or data input from the outside of the electronic device 301. In an optional or additional embodiment, the RAM may be used as a storage area corresponding to various tasks performed by the electronic device 301. Alternatively or additionally, the processor 330 may include a read-only memory (ROM) storing a control program and/or a plurality of instructions for control of the electronic device 301, and at least one processor.

Alternatively or additionally, the processor 330 may include a graphics processing unit (GPU) for graphic processing corresponding to a video. In an embodiment, the processor 330 may be implemented as a system-on-chip (SoC) in which a core and the GPU are integrated. Alternatively or additionally, the processor 330 may include a multi-core greater than a single core. For example, the processor 330 may include a dual-core, a triple-core, a quad-core, a hexa-core, an octa-core, a deca-core, a dodeca-core, or hexadeca-core.

The processor 330 may be configured as a main central processing unit (CPU). For example, after waking up, the processor 330 may control the electronic device 301 to perform a certain operation.

FIG. 3B is a block diagram of an electronic device, according to an embodiment. An electronic device 300 shown in FIG. 3B may include or may be similar in many respects to the electronic device 301 described with reference to FIG. 3A, and may include additional features not mentioned above. Accordingly, while describing the electronic device 300 according to an embodiment, descriptions that overlap those of FIG. 3A may be omitted.

In an embodiment, the electronic device 300 may further include a microcomputer 320 compared to the electronic device 301 described in FIG. 3A.

In an optional or additional embodiment, the electronic device 300 may include the Wi-Fi module 310 including the internal memory 311, the microcomputer 320, and the processor 330 configured to execute at least one instruction. Alternatively or additionally, based on the receiving of the first request for the AP transition from the first AP while the processor 330 is in the suspend mode, the Wi-Fi module 310 may store the first request in the internal memory 311, generate the wakeup signal, transmit the wakeup signal to the microcomputer 320, and transmit the first request stored in the internal memory 311 to the processor 330 after the processor 330 wakes up according to control by the microcomputer 320.

In an embodiment, the processor 330 may wake up according to control by the microcomputer 320 that received the wakeup signal, and control the Wi-Fi module 310 such that the first response corresponding to the first request is transmitted to the first AP, based on the first request received from the Wi-Fi module 310.

In the electronic device 301 shown in FIG. 3A, the wakeup signal generated by the Wi-Fi module 310 may be transmitted directly to the processor 330 from the Wi-Fi module 310. Alternatively or additionally, in the electronic device 300 shown in FIG. 3B, the wakeup signal generated by the Wi-Fi module 310 may be transmitted to the microcomputer 320, and the microcomputer 320 may transmit a signal (e.g., a control signal requesting wakeup or a power-on signal) for waking the processor 330 up, based on the received wakeup signal. Remaining operations of the electronic device 300 may be the same as those of the electronic device 301, and thus redundant descriptions thereof are omitted.

In an embodiment, the microcomputer 320 may wake the processor 330 up. That is, the microcomputer 320 may be a microprocessor that wakes the processor 330 up.

For example, the microcomputer 320 may wake the processor 330 up, based on the wakeup signal received from the Wi-Fi module 310. In other words, the microcomputer 320 may wake the processor 330 up in response to receiving of the wakeup signal.

For another example, the microcomputer 320 may operate as a timer. That is, the microcomputer 320 may operate to wake the processor 330 up periodically (e.g., at a certain period having a certain duration). For example, the microcomputer 320 may periodically control the processor 330 in the suspend mode to wake up according to a certain operation period.

In an embodiment, the working mode of the processor 330 woken up according to control by the microcomputer 320 may be changed from the suspend mode to the LPM. Alternatively or additionally, the working mode of the processor 330 woken up according to control by the microcomputer 320 may be changed from the suspend mode to the normal mode.

In an embodiment, even when the working mode of the electronic device 300 is the suspend mode, the microcomputer 320 may receive power and maintain an on-state. Accordingly, even in the suspend mode, the microcomputer 320 may receive and process the wakeup signal from the Wi-Fi module 310. Alternatively or additionally, even in the suspend mode, the microcomputer 320 may start a timer to count a set time, and wake the processor 330 up periodically at set time intervals.

In FIG. 3B, the microcomputer 320 is illustrated as a separate component from the Wi-Fi module 310, however, the present disclosure is not limited in this regard. For example, the microcomputer 320 may be included in the Wi-Fi module 310. In this case, when the electronic device 300 enters the suspend mode, power may be supplied to the microcomputer 320 included in the Wi-Fi module 310 when power is supplied to the Wi-Fi module 310. When an electronic device according to an embodiment does not include a microcomputer as a separate component, the Wi-Fi module 310 may perform the operations of the microcomputer 320 (e.g., operations performed to wake the processor 330 up). For example, when the electronic device 300 according to an embodiment does not include the microcomputer 320 as a separate component, the Wi-Fi module 310 may perform a timer operation of the microcomputer 320. Hereinafter, an electronic device according to an embodiment, in which the Wi-Fi module 310 and the microcomputer 320 are provided as independent components, is described and illustrated as an example.

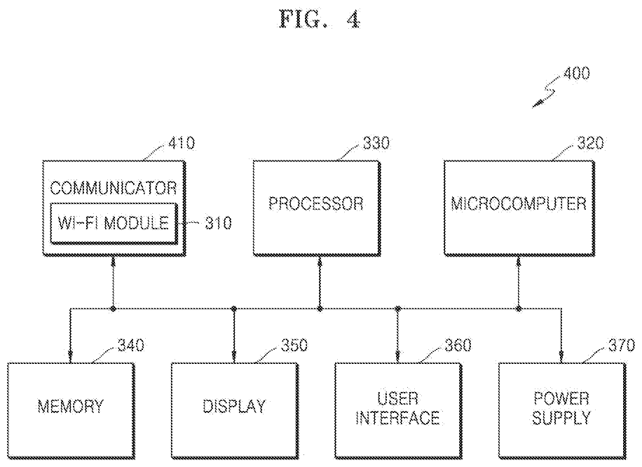

In FIGS. 4 to 13, an example in which an operation of waking the processor 330 up is performed by the microcomputer 320 is described.

FIG. 4 is a block diagram of an electronic device, according to an embodiment. An electronic device 400 shown in FIG. 4 may include or may be similar in many respects to the electronic device 301 or 300 shown in FIG. 3A or 3B, and may include additional features not mentioned above. Thus, while describing the electronic device 400, descriptions that overlap those of FIG. 3A or 3B may be omitted.

Referring to FIG. 4, the electronic device 400 may include a communicator 410 including the Wi-Fi module 310 described in FIG. 3A or 3B. Alternatively or additionally, compared to the electronic device 301 or 300 of FIG. 3A or 3B, the electronic device 400 may further include at least one of a memory 340, a display 350, a user interface 360, and a power supply 370.

The communicator 410 may perform communication with an external electronic device through at least one wired or wireless communication network. According to an embodiment, the communicator 410 may communicate with the external electronic device. In an embodiment, the external electronic device may include a server and/or the communicator 410 may perform communication with the server. The server may provide an IoT environment, and may include a content providing server and/or an Internet server. Alternatively or additionally, when the communicator 410 communicates with the external electronic device, the wireless communication network through an AP may be used and/or a communication relay of the server may be used.

In an embodiment, the communicator 410 may include at least one communication module and a communication circuit, and may transmit/receive data to/from the external electronic device through the communication module and/or the communication circuit.

In an embodiment, the communicator 410 may include at least one short-range communication module performing communication according to a communication standard, such as, but not limited to, Bluetooth™, Wi-Fi, Bluetooth™ low energy (BLE), near field communication (NFC)/radio frequency identification (RFID), Wi-Fi direct (WFD), ultra-wideband (UWB), or ZigBee.

In an embodiment, the communicator 410 may further include a long-range communication module performing communication with a server for supporting long-range communication according to the long-range communication standard. For example, the communicator 410 may include the long-range communication module performing communication through a network for Internet communication. Alternatively or additionally, the communicator 410 may include a communication network following a communication standard, such as, but not limited to, 3rd generation (3G), 4th generation (4G), 5th generation (5G), and/or 6th generation (6G).

In an embodiment, the communicator 410 may include a short-range communication module, (e.g., an infrared (IR) communication module) capable of receiving a control command from a remote controller. In this case, the communicator 410 may receive a control command from the remote controller. For example, the control command received from the remote controller may include a turn-on or turn-off command.

The memory 340 may store at least one instruction. The memory 340 may store at least one instruction executed by the processor 330. Alternatively or additionally, the memory 340 may store at least one program executed by the processor 330. In an embodiment, the memory 340 may store information or data used for operations of the electronic device 400. In an optional or additional embodiment, the memory 340 may store content reproduced by the electronic device 400.

In an embodiment, the memory 340 may include at least one type of storage medium among a flash memory type, a hard disk type, a multimedia card micro type, a card type memory (e.g., a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk.

The display 350 may output an image. For example, the display 350 may output an image corresponding to video data, through a display panel included therein such that a user may visually recognize the video data.

The user interface 360 may receive a user input for controlling the electronic device 400. The user interface 360 may include, but not be limited to, a user input device including a touch panel detecting the user's touch, a button receiving a push operation of the user, a wheel receiving a rotation operation of the user, a keyboard, and a dome switch, but is not limited thereto.

The user interface 360 may include a voice recognition device for voice recognition. For example, the voice recognition device may include a microphone and may receive the user's voice command or voice request. Accordingly, the processor 330 may control an operation corresponding to the voice command or voice request to be performed.

In an embodiment, the user interface 360 may include a motion detection sensor. For example, the motion detection sensor may detect movement of the electronic device 400 and receive the detected movement as a user input. Alternatively or additionally, the voice recognition device and the motion detection device may not be included in the user interface 360, but may be included in the electronic device 400 as independent modules from the user interface 360.

According to an embodiment, the user interface 360 may receive a user input of requesting to turn off the electronic device 400 while the electronic device 400 is displaying an image. Based on the user input, the processor 330 may control the electronic device 400 to enter a suspend mode in response to the received user input. For example, the display 350 of the electronic device 400 that entered the suspend mode may be switched to a black screen state, and power may be supplied only to the communicator 410 while power supply to other components is blocked.

The power supply 370 may supply power to components inside the electronic device 400 under control by the processor 330. For example, the power supply 370 may supply power input from an external power source to the components inside the electronic device 400 under control by the processor 330. For another example, the power supply 370 may supply power output from one or more batteries located inside the electronic device 400 to the internal components, under control by the processor 330.

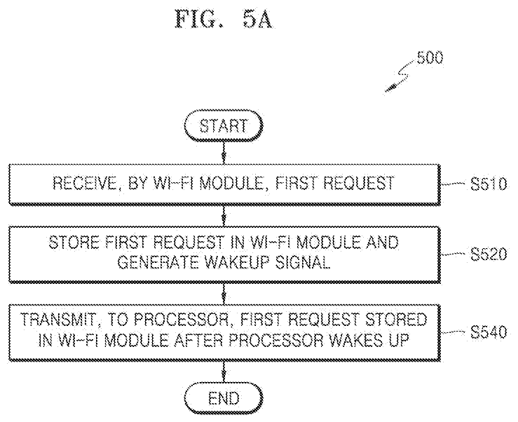

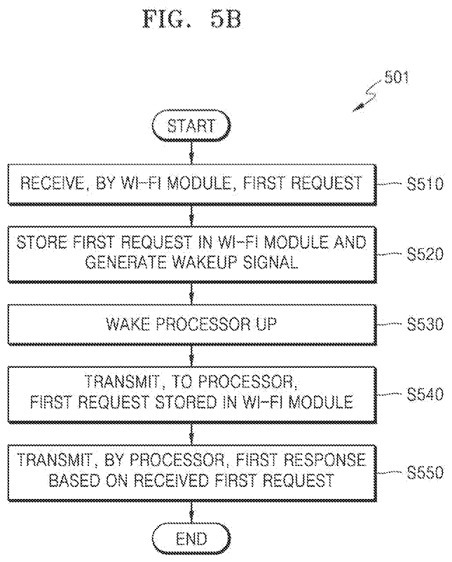

Hereinafter, operations performed by the electronic device 120, 301, 300, or 400, according to an embodiment, are described with reference to FIGS. 5A to 8.

FIG. 5A is a flowchart of an operating method of an electronic device, according to an embodiment. Referring to FIG. 5A, an operating method 500 of an electronic device (e.g., electronic device 120, 301, 300, or 400) indicates a flow of operations, according to an embodiment. Thus, descriptions about operations included in the operating method 500 of the electronic device, according to an embodiment, which overlap those of the operations of the electronic device 120, 301, 300, or 400 described with reference to FIGS. 1 to 4, may be omitted.

Hereinafter, an example in which the operating method 500 of the electronic device is performed through the electronic device 300 of FIG. 3B is described.

The operating method 500 of the electronic device, according to an embodiment, may be an operating method of the electronic device 300 including the Wi-Fi module 310 that includes the internal memory 311, the processor 330 executing at least one instruction, and the microcomputer 320.

Referring to FIG. 5A, the operating method 500 of the electronic device includes receiving, by the Wi-Fi module 310, the first request for the AP transition from the first AP while the processor 330 is in the suspend mode (operation S510). Operation S510 may be performed by the Wi-Fi module 310. The first AP may denote an AP the electronic device 300 accesses to access the Wi-Fi network at a time point when the first request is received, and may not denote a specific AP or an AP the electronic device 300 has first accessed.

In an embodiment, the first request may include a signal requesting transition of an AP. When a current state of the first AP is a high load state or a low throughput is expected for the first AP, the electronic device 300 may be unable to seamlessly communicate through the Wi-Fi network. In this case, the first AP may transmit, to the electronic device 300 accessing the first AP, a signal requesting to transition an access to another adjacent available AP.

In an embodiment, the first AP may identify an AP in a low load state or a high throughput expected AP from among adjacent APs accessible by the electronic device 300. Alternatively or additionally, the first AP may transmit, to the Wi-Fi module 310 of the electronic device 300, a first signal that is a signal requesting to transition the access to the identified AP.

In an embodiment, the first request may denote a signal requesting a BSS to be changed by moving an AP. For example, the first request may include a BSS transition management (BTM) request. The BTM request may also be referred to as a BTM request frame.

In an embodiment, the BTM request may denote a signal requesting the BSS to be changed by moving an AP for Wi-Fi network management. For example, the BTM request may include a Wi-Fi network management (WNM) BTM request. The WNM BTM request may also be referred to as a WNM BTM request frame.

The electronic device 300 may maintain a state of transmitting/receiving data through the Wi-Fi network, even in the suspend mode or LPM. For example, even in the suspend mode or LPM, the electronic device 300 may maintain a connection between the Wi-Fi module 310 and an AP (e.g., the first AP). For example, after the connection between the Wi-Fi module 310 and the AP (e.g., the first AP) is established, the first AP may periodically transmit, to the Wi-Fi module 310, a signal for identifying a communication connection. For example, the first AP may maintain and identify the communication connection to the Wi-Fi module 310 by periodically broadcasting a beacon every certain time interval.

According to an embodiment, even after entering the suspend mode, the electronic device 300 may maintain an access to the Wi-Fi network through the first AP as described above, and receive the first request through the Wi-Fi network accessed through the first AP.

The operating method 500 of the electronic device may include storing the first request received in operation S510 in the internal memory 311 and generating the wakeup signal (operation S520). Operation S520 may be performed by the Wi-Fi module 310.

In an embodiment, when the Wi-Fi module 310 includes the microcomputer 320 therein and/or the Wi-Fi module 310 performs functions of the microcomputer 320 that wakes the processor 330 up, the Wi-Fi module 310 may directly transmit, to the processor 330, the wakeup signal and/or a power-on request corresponding to the wakeup signal.

Alternatively or additionally, when the electronic device 301 includes the microcomputer 320 as a separate component, the operating method 500 of the electronic device may include storing the first request received in operation S510 in the internal memory 311, generating the wakeup signal, and transmitting the wakeup signal to the microcomputer 320 (operation S520).

In an embodiment, the operating method 500 of the electronic device may include transmitting the first request stored in the internal memory 311 included in the Wi-Fi module 310 to the processor 330 after the processor 330 wakes up based on the wakeup signal generated in operation S520 (operation S540). Operation S540 may be performed by the Wi-Fi module 310.

Alternatively or additionally, the operating method 500 of the electronic device may include transmitting the first request stored in the internal memory 311 included in the Wi-Fi module 310 to the processor 330 after the processor 330 wakes up according to control by the microcomputer 320 (operation S540). Operation S540 may be performed by the Wi-Fi module 310. For example, when the wakeup signal generated in operation S520 is transmitted to the microcomputer 320, the microcomputer 320 may control the processor 330 to wake up based on the received wakeup signal.

For another example, when a set time has elapsed after the wakeup signal is transmitted in operation S520, the Wi-Fi module 310 may identify whether the processor 330 woke up and transmit the first request stored in the internal memory 311 to the processor 330, based on a result of the identifying.

In an embodiment, based on receiving a signal indicating that the processor 330 woke up after the wakeup signal is transmitted in operation S520, the Wi-Fi module 310 may read the first request stored in the internal memory 311 and transmit the first request to the processor 330. For example, the signal indicating that the processor 330 woke up may be transmitted from the processor 330 to the Wi-Fi module 310.

In an optional or additional embodiment, the first request transmitted from the Wi-Fi module 310 to the processor 330 in operation S540 may be distinguished from the first request received in operation S510. For example, the first request transmitted in operation S540 may be a request read from the internal memory 311 and transmitted to the processor 330 after the first request received in operation S510 is stored in the internal memory 311 included in the Wi-Fi module 310.

In a related electronic device, when a related electronic device is in a suspend mode, the related electronic device may be unable to process operations required to transition an AP even when a request requesting to transition the AP is received. For example, even when a BTM request is received by a Wi-Fi-module, there may be no method by which a processor in a suspend mode may receive and process the BTM request. According to an embodiment, based on receiving the request (e.g., the first request) to transition an AP, the Wi-Fi module 310 of the electronic device (e.g., the electronic device 300) operates to transmit the first request to be transmitted to the processor 330 that work up, without ignoring the received first request. For example, the Wi-Fi module 310 may store the first request in the internal memory 311 included in the Wi-Fi module 310 and/or may transmit the stored first request to the processor 330 that woke up after the processor 330 wakes up, such that the electronic device 300 in the suspend mode performs the AP transition.

Thus, according to an electronic device (e.g., the electronic device 120, 301, 300, or 400) according to an embodiment and an operating method thereof, an AP may be transitioned even in a suspended state and thus high network access quality may be maintained.

FIG. 5B is a flowchart of an operating method of an electronic device, according to an embodiment. Referring to FIG. 5B, an operating method 501 of an electronic device (e.g., electronic device 120, 301, 300, or 400) indicates a flow of operations performed through a display device according to an embodiment. Alternatively or additionally, the operations included in the operating method 501 of the electronic device shown in FIG. 5B, which are substantially similar as those in the operating method 500 shown in FIG. 5A, are illustrated by using same reference numerals. Thus, while describing the operating method 501 of the electronic device, descriptions that overlap those of the operations of the electronic device 120, 301, 300, or 400 described with reference to FIGS. 1 to 5A may be omitted.

Hereinafter, an example in which the operating method 501 of the electronic device is performed through the electronic device 300 of FIG. 3B is described.

Referring to FIG. 5B, the operating method 501 of the electronic device includes receiving, by the Wi-Fi module 310, the first request for the AP transition from the first AP while the processor 330 is in the suspend mode (operation S510). Operation S510 may be performed by the Wi-Fi module 310.

The operating method 501 of the electronic device includes storing the first request received in operation S510 in the internal memory 311 and generating the wakeup signal (operation S520). Operation S520 may be performed by the Wi-Fi module 310.

Alternatively or additionally, the operating method 501 of the electronic device includes storing the first request received in operation S510 in the internal memory 311, generating the wakeup signal, and transmitting the wakeup signal to the microcomputer 320 (operation S520). Then, subsequent to operation S520, the operating method 501 of the electronic device may include controlling the processor 330 to wake up according to control by the microcomputer 320 (operation S530). Operation S530 may be performed by the microcomputer 320.

In an embodiment, the operating method 501 of the electronic device may include transmitting, by the microcomputer 320, the power-on signal to the processor 330, based on the wakeup signal transmitted from the Wi-Fi module 310. The processor 300 may wake up based on reception of the power-on signal. In an embodiment, the power-on signal may include a signal requesting and/or controlling the processor 330 to change the working state from the suspend mode to the LPM, by supplying power to the processor 330. Upon receiving the power-on signal, the processor 330 may change the working state from an inactivated state to an activated state by receiving power.

As described above, when the working mode of the electronic device 300 is largely distinguished as the normal mode and the suspend mode, the LPM may be included in the suspend mode. Alternatively or additionally, when the working mode is largely distinguished as the normal mode and the suspend mode in terms of the processor 330, because power is supplied to the processor 330 in the LPM, the LPM may be included in the normal mode in terms of the processor 330. Accordingly, when the processor 330 wakes up based on the reception of the power-on signal, it may be considered that the processor 330 enters the normal mode, but from the point of view of the electronic device 300, the electronic device 300 enters the LPM, and thus may still be in the suspend mode. When the LPM and the suspend mode are clearly distinguished from each other, it may be considered that the electronic device 300 enters the LPM.

After the processor 330 wakes up based on the wakeup signal, the operating method 501 of the electronic device includes reading the first request stored in the internal memory 311 and transmitting the first request to the processor 330 (operation S540). Operation S540 may be performed by the Wi-Fi module 310. In other words, the operating method 501 of the electronic device includes reading the first request stored in the internal memory 311 and transmitting the first request to the processor 330 after the processor 330 wakes up based on the wakeup signal generated in operation S520 (operation S540).

In an embodiment, the operating method 501 of the electronic device may include reading the first request stored in the internal memory 311 and transmitting the first request to the processor 330 after the processor 330 wakes up according to control by the microcomputer 320 (operation S540). Operation S540 may be performed by the Wi-Fi module 310.

Subsequent to operation S540, the operating method 501 of the electronic device may include controlling, by the processor 330, the Wi-Fi module 310 such that the first response corresponding to the first request is transmitted to the first AP, based on the first request received in operation S540 (operation S550). Operation S550 may be performed according to control by the processor 330. In an embodiment, the first response may include a signal indicating that the first request is accepted and/or that a BSS is changed by moving an AP.

For example, the first response may be a BTM response indicating acceptance of the BTM request. The BTM response may also be referred to as a BTM response frame.

In an embodiment, the BTM response may denote a signal indicating that the BSS is to be changed by moving an AP for Wi-Fi network management. For example, the BTM response may be a WNM BTM response. The WNM BTM response may also be referred to as a WNM BTM response frame.

After the electronic device 300 transmits the first response to the first AP, the processor 330 may perform an operation for AP transition.

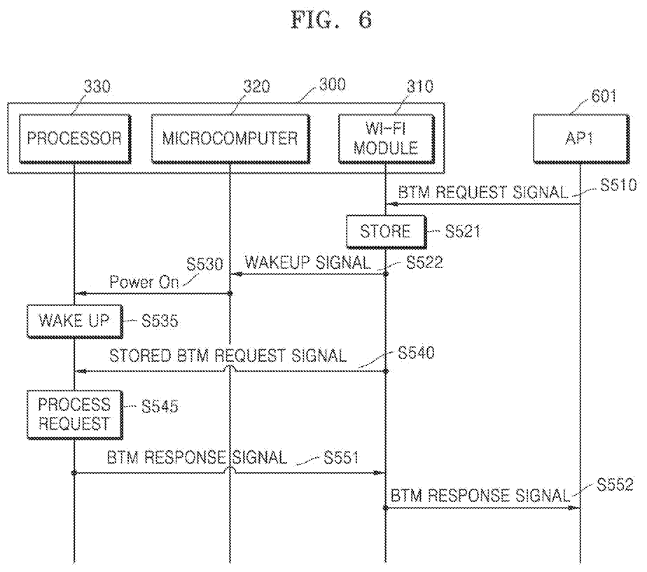

FIG. 6 is a diagram describing an operating method of an electronic device, according to an embodiment. For example, FIG. 6 is a diagram describing operations performed by the electronic device 120, 301, 300, or 400, according to an embodiment. Among the operations shown in FIG. 6, those substantially similar to FIGS. 5A and 5B are illustrated by using same reference numerals. Thus, while describing the operations of FIG. 6, descriptions overlapping those of FIGS. 1 to 5B may be omitted.

Hereinafter, for convenience of description, an example in which the operations shown in FIG. 6 are performed by the electronic device 300 of FIG. 3B is described. Thus, the Wi-Fi module 310 shown in FIG. 6 may include the internal memory 311.

In FIG. 6, the first AP described above is simply indicated as an AP1 601, and an example in which the first request is a BTM request signal and the first response is a BTM response signal is described.

Referring to FIG. 6, the AP1 601 may transmit the BTM request signal to the Wi-Fi module 310 when a state of the AP1 601 is not a state capable of seamlessly communicating through the Wi-Fi network. The electronic device 300 is in the suspend mode at a time point when the Wi-Fi module 310 receives the BTM request signal. In other words, the Wi-Fi module 310 of the electronic device 300 in the suspend mode may receive the BTM request signal (operation S510).

Referring to FIG. 6, operation S520 described in FIGS. 5A and 5B may include operations S521 and S522. For example, the Wi-Fi module 310 may store the BTM request signal received in operation S510, in the internal memory 311 (operation S521). In response to the reception of the BTM request signal, the Wi-Fi module 310 may generate the wakeup signal and transmit the wakeup signal to the microcomputer 320 (operation S522).

The microcomputer 320 may wake the processor 330 up, based on the wakeup signal received in operation S522. For example, the microcomputer 320 may transmit, to the processor 330, the power-on signal for waking the processor 330 up, in response to the wakeup signal received in operation S522 (operation S530).

The processor 330 may wake up according to control by the microcomputer 320 (operation S535).

When the processor 330 wakes up, the Wi-Fi module 310 may read the BTM request signal stored in the internal memory 311 and transmit the read BTM request signal to the processor 330.

In an embodiment, after identifying that the processor 330 woke up, the Wi-Fi module 310 may read the BTM request signal stored in the internal memory 311 and transmit the read BTM request signal to the processor 330 (operation S540).

For example, the Wi-Fi module 310 may identify that the processor 330 woke up, based on a signal transmitted from the processor 330. For example, after waking up, the processor 330 may transmit, to the Wi-Fi module 310, the signal indicating the wakeup. In an embodiment, the Wi-Fi module 310 and the processor 330 may be connected to each other through a communication interface, for example, a universal serial bus (USB), a serial peripheral interface (SPI), or a medium independent interface (XMII). When the processor 330 wakes up and thus is able to transmit/receive a signal to/from the Wi-Fi module 310, the processor 330 may transmit, to the Wi-Fi module 310, a signal indicating the same, for example, a USB ready signal. Then, upon receiving the USB ready signal, the Wi-Fi module 310 may identify that the processor 330 woke up.

Alternatively or additionally, the Wi-Fi module 310 may transmit, to the processor 330, a signal for identifying the wakeup, and identify whether the processor 330 transmits a response signal in response thereto. In this case, the Wi-Fi module 310 may determine that the processor 330 woke up, based on reception of the response signal.

Continuing to refer to FIG. 6, the processor 330 may process the BTM request signal transmitted in operation S540 (operation S545). For example, to process a request for AP transition according to the BTM request signal, the processor 330 may generate a BTM response signal and perform a preparation operation for the AP transition.

The processor 330 may control the BTM response signal to be transmitted to the AP1 601 through the Wi-Fi module 310. For example, the processor 330 may transmit the BTM response signal to the Wi-Fi module 310 (operation S551). The Wi-Fi module 310 may transmit the BTM response signal received from the processor 330 to the AP1 601 (operation S552).

Upon receiving the BTM response signal, the AP1 601 may transmit, to another AP, information required for a connection to the electronic device 300, such that a connection to the electronic device 300 is released and the electronic device 300 may access the other AP. Alternatively or additionally, the first AP may transmit, to the electronic device 300, information required for a communication connection to the other AP.

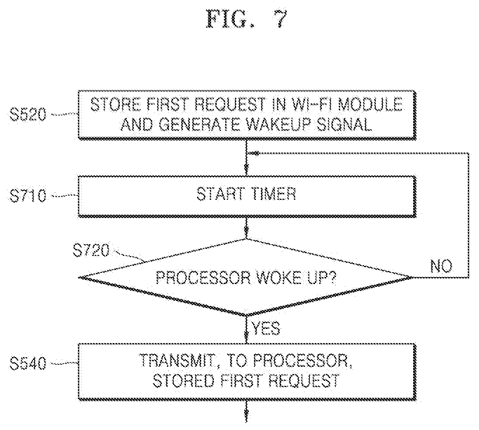

FIG. 7 is a diagram describing an operation of identifying wakeup of a processor in an operating method of an electronic device, according to an embodiment. For example, operations performed by the Wi-Fi module 310 included in the electronic device 120, 301, 300, or 400, according to an embodiment of FIG. 7, to identify the wakeup of the processor 330, are described. Among the operations shown in FIG. 7, those substantially similar to FIGS. 5A and 5B may be illustrated by using same reference numerals.

Referring to FIG. 7, the Wi-Fi module 310 may start a timer to count a certain period of time after performing operation S520 (operation S710). In an embodiment, the timer may be included in the Wi-Fi module 310. Alternatively or additionally, the timer may be included in the microcomputer 320 and, in this case, the Wi-Fi module 310 may request the microcomputer 320 to start the timer.

When a certain set period of time has elapsed through the timer according to running of the timer, the Wi-Fi module 310 may identify whether the processor 330 woke up (operation S720). As described above, the identifying in operation S720 may be performed based on whether the Wi-Fi module 310 has received the signal indicating that the processor 330 is in the state capable of transmitting/receiving a signal to/from the Wi-Fi module 310, (e.g., a USB ready signal) within the certain set period of time.

When the Wi-Fi module 310 identifies/determines that the processor 330 woke up in operation S720, the Wi-Fi module 310 reads the first request stored in the internal memory 311 and transmits the first request to the processor 330 (operation S540).

When the Wi-Fi module 310 identifies/determines that the processor 330 did not wake up in operation S720, the Wi-Fi module 310 may return to operation S710 and start the timer again.

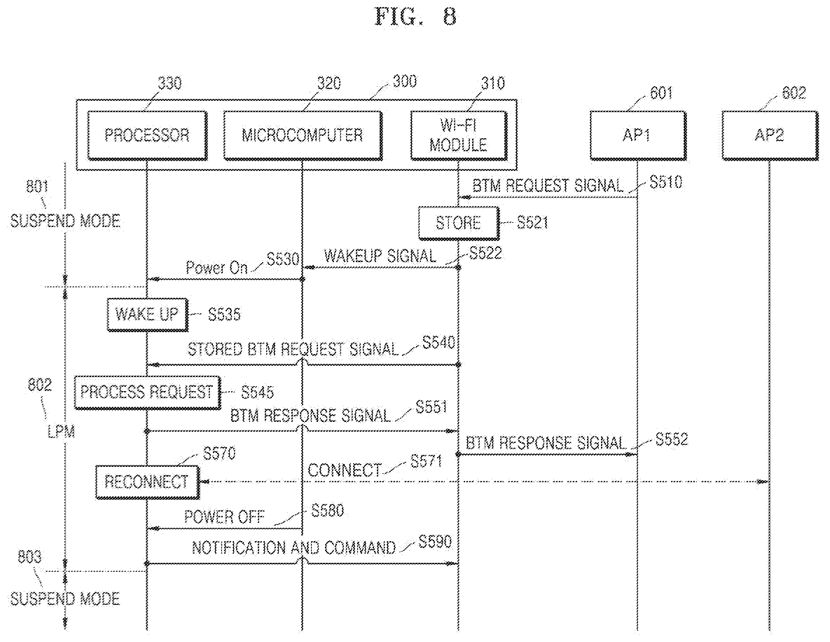

FIG. 8 is a diagram describing an operating method of an electronic device, according to an embodiment. For example, FIG. 8 is a diagram describing operations performed by the electronic device 120, 301, 300, or 400, according to an embodiment. Among the operations shown in FIG. 8, those substantially similar to FIGS. 5A, 5B, and 6 may be illustrated by using same reference numerals. Thus, while describing the operations of FIG. 8, descriptions overlapping those of FIGS. 1 to 7 may be omitted.

Hereinafter, for convenience of description, an example in which the operations shown in FIG. 8 are performed by the electronic device 300 is described. Thus, the Wi-Fi module 310 shown in FIG. 8 includes the internal memory 311.

Referring to FIG. 8, the electronic device 300 may be in a suspend mode 801 before the processor 330 wakes up in operation S535. Alternatively or additionally, when the processor 330 wakes up in operation S535, the working state of the electronic device 300 may be changed from the suspend mode 801 to an LPM 802. In the LPM 802, power may be supplied to the Wi-Fi module 310, microcomputer 320, and processor 330 included in the electronic device 300. In an embodiment, in the LPM 802, power may not be supplied to other components included in the electronic device (e.g., the electronic device 400), such as, but not limited to, the memory 340, the display 350, and the user interface 360. Accordingly, when the electronic device 300 includes a display, the display may maintain an off-state and thus may maintain a state of outputting a black screen.

When the processor 330 wakes up, the processor 330 may transmit, to the Wi-Fi module 310, the BTM response signal corresponding to the BTM request signal transmitted in operation S540 (operation S551).

The processor 330 may control an AP the Wi-Fi module 310 accesses to move from the AP1 601 to a second AP (AP2) 602. For example, the processor 330 may perform operations S570 and S571. In an embodiment, the AP2 602 may include an AP accessible by the electronic device 300, and/or may include an AP in a low load state and/or a high throughput expected AP compared to the AP1 601. Alternatively or additionally, the AP2 602 may be an AP identified or designated, by the AP1 601, as a target of the AP transition of the electronic device 300.

In an embodiment, operations required for the AP2 602 and the electronic device 300 to be communicably connected to each other may be performed (operation S570). For example, in operation S570, the processor 330 may obtain information required for a communication connection with the AP2 602. Then, based on the obtained information required for the communication connection, the processor 330 may control the electronic device 300 and the AP2 602 to be communicably connected to each other. For example, the processor 330 may obtain, from the AP1 601, SSID and an MAC address of the AP2 602 required for the communication connection to the AP2 602.

Accordingly, the electronic device 300 may release the communication connection with the AP1 601 and establish the communication connection with the AP2 602 (operation S571). Accordingly, the Wi-Fi module 310 may access the AP2 602, and the Wi-Fi module 310 may access the Wi-Fi network through the AP2 602.

Based on the AP transition being completed, the processor 330 may enter a suspend mode 803 that is an original state.

In an embodiment, the microcomputer 320 may transmit, to the processor 330, a signal requesting or commanding the processor 330 to enter a suspend mode, for example, a power-off signal (operation S580). For example, when the AP transition is completed and thus the electronic device 300 accesses the AP2 602, the microcomputer 320 may transmit the power-off signal to the processor 330 (operation S580).

Based on the power-off signal transmitted from the microcomputer 320, the processor 330 may entire the suspend mode 803 to be in a sleep state, (e.g., the original state).

In an embodiment, the processor 330 may transmit, to the Wi-Fi module 310, a command for maintaining a connection with the AP2 602 and a notification indicating entrance to a suspend mode, based on the AP transition being completed (operation S590). After operation S590, the processor 330 may enter the suspend mode 803. Accordingly, the processor 330 may return to the original working state.

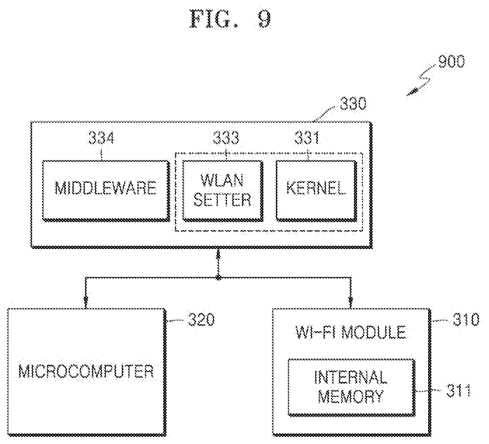

FIG. 9 is a block diagram of an electronic device, according to an embodiment.

An electronic device 900 shown in FIG. 9 may include or may be similar in many respects to the electronic device 300 shown in FIG. 3B, and may include additional features not mentioned above. Thus, while describing the electronic device 900, descriptions that overlap those of FIG. 3B are omitted.

Referring to FIG. 9, the processor 330 may include a middleware 334, a WLAN setter 333, and a kernel 331.

For example, the middleware 334, the WLAN setter 333, and the kernel 331 may be distinguished and provided as software. For example, the middleware 334, the WLAN setter 333, and the kernel 331 may be provided in a set of at least one instruction such that operations distinguished from each other are performed by the at least one instruction.

The kernel 331 may be formed as a driver transmitting/receiving a signal to/from the Wi-Fi module 310. For example, the kernel 331 may perform a function of delivering, to the Wi-Fi module 310, an event, signal, command, request, and/or information generated by the middleware 334 or WLAN setter 333. Alternatively or additionally, the kernel 331 may deliver, to the middleware 334 or WLAN setter 333, an event, signal, command, request, and/or information delivered from the Wi-Fi module 310. The kernel 331 may also be referred to as a driver or a Wi-Fi driver.

The WLAN setter 333 may perform settings required for a Wi-Fi network connection by performing WLAN setting called Wi-Fi-protected access (WPA) supplicant. For example, the WLAN setter 333 may perform functions of a Wi-Fi manager performing operations required to control Wi-Fi communication. Hereinbelow, the WLAN setter 333 of FIG. 9 is illustrated as a WPA supplicant 333.

The middleware 334 may perform actual control for connecting, maintaining, or changing a Wi-Fi network.

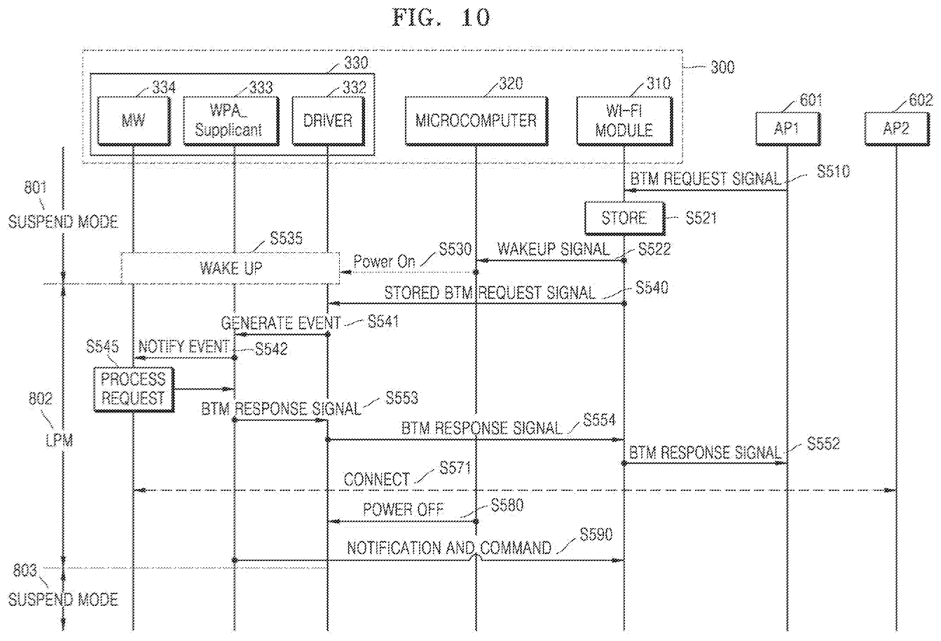

Hereinafter, detailed operations of the processor 330 including the middleware 334, the WLAN setter 333, and the kernel 331 is described with reference to FIG. 10. Alternatively or additionally, the middleware 334, the WLAN setter 333, and the kernel 331 described in FIG. 9 are respectively illustrated as an MW, a WPA_supplicant, and a driver in FIG. 10, which are corresponding terms.

FIG. 10 is a diagram describing an operating method of an electronic device, according to an embodiment. For example, FIG. 10 is a diagram describing operations performed by the electronic device 120, 300, 400, or 900, according to an embodiment. Among the operations shown in FIG. 10, those substantially similar to FIGS. 1 and 9 are illustrated by using same reference numerals. Thus, while describing the operations of FIG. 10, descriptions overlapping those of FIGS. 1 to 9 may be omitted.

Hereinafter, for convenience of description, an example in which the operations shown in FIG. 10 are performed by the electronic device 900 of FIG. 9 is described. The operations of FIG. 10, not previously described with reference to FIG. 8, are described.

Referring to FIG. 10, the BTM request signal transmitted in operation S540 may be transmitted to a driver 332. For example, operation S540 described with reference to FIGS. 6 and 8 may include operations S541 and S542. That is, the driver 332 may generate an event corresponding to the received BTM request signal, and transmit the vent to the WPA_supplicant 333 (operation S541). The event may be an event signal indicating that the BTM request signal has been received. The WPA_supplicant 333 may transmit a signal indicating the event to the MW 334 (operation S542).

The MW 334, which has received the event transmitted in operation S542, may process a request corresponding to the event (operation S545). For example, in response to the event, the MW 334 may perform control for transitioning an AP.

In an embodiment, the MW 334 may control the WPA_supplicant 333 such that the BTM response signal corresponding to the BTM request signal is transmitted to the AP1 601. According to control by the MW 334, the WPA_supplicant 333 may generate the BTM response signal and transmit the BTM response signal to the driver 332 (operation S553). The driver 332 may transmit the BTM response signal to the Wi-Fi module 310 (operation S554).

According to control by the MW 334, operation S571 described with reference to FIG. 8 may be performed.

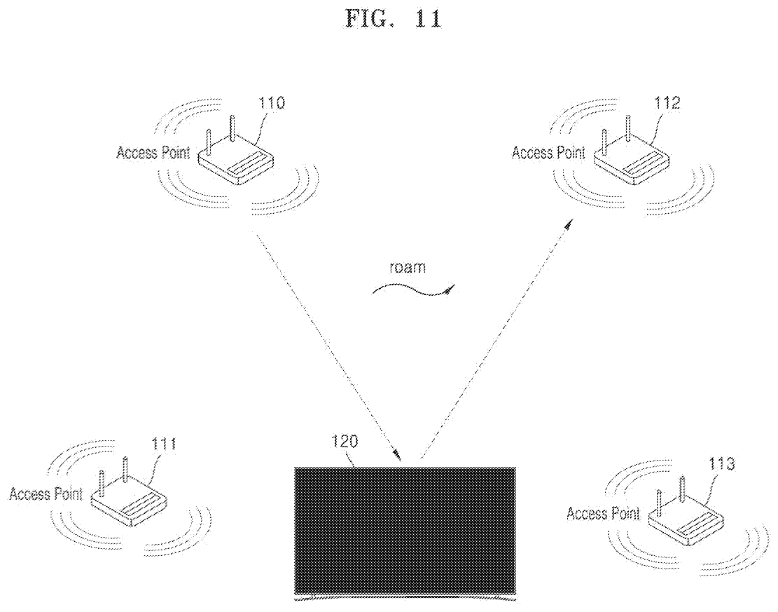

FIG. 11 is a diagram describing transition of an AP accessed by an electronic device in a suspend mode, according to an embodiment. In FIG. 11, substantially similar components as in FIG. 2 may be illustrated using same reference numerals. The electronic device 120 may include or may be similar in many respects to the electronic device 300, 400, or 900 described with reference to FIGS. 3 to 9, and may include additional features not mentioned above.

Referring to FIG. 11, the electronic device 120 may transition and/or change between Aps, even in the suspend mode. When the electronic device 120 is a display device outputting an image through a display, the electronic device 120 in the suspend mode may output a black screen as shown in FIG. 11.

As described with reference to FIGS. 8 and 10, the electronic device 120, according to an embodiment, may receive the first signal (e.g., the BTM request signal) requesting the AP transition while in the suspend mode 801, perform the AP transition by changing the working state to the LPM 802, and enter the suspend mode 803 that is the original state again. For example, the electronic device 120 may change and/or transition an AP being accessed in the suspend mode from the AP 110 to an AP 112, according to an operating method according to an embodiment.

Accordingly, the electronic device 120 may complete the AP transition while continuously outputting the black screen without having to change to a normal state. Thus, according to an embodiment, the electronic device 120 in the suspend mode may perform operations required for the AP transition without having to change the working state to the normal state, and thus may continuously maintain a state of accessing the Wi-Fi network having a high signal quality. Accordingly, the electronic device 120 may maintain the high signal quality of the accessed Wi-Fi network while reducing power consumption.

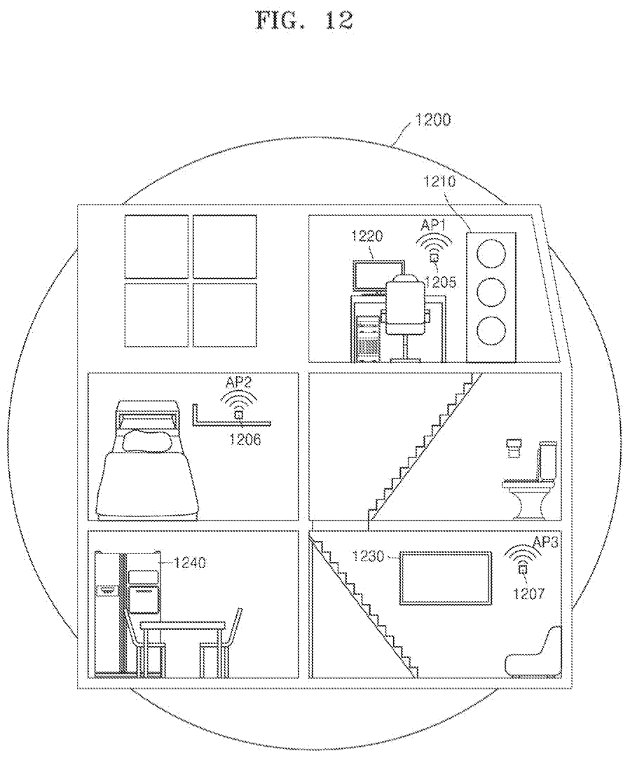

FIG. 12 is a diagram describing an example of using an electronic device, according to an embodiment.

The electronic device 120, 300, 400, or 900, according to an embodiment, may include a wireless client device located in a mesh network 1200 formed by a plurality of APs.

The mesh network 1200 may denote a network including a plurality of APs in a certain space such that electronic devices located in the certain space accesses at least one of the plurality of APs.

The mesh network 1200 may be a wireless communication network formed by expanding an existing Wi-Fi zone accessible to one AP to a wider range. For example, the mesh network 1200 may be formed in units of homes, at least one building, or a plurality of adjacent spaces.

FIG. 12 illustrates an example in which a house of a user is a detached house including three floors. The mesh network 1200 may be formed in the house of the user. In this case, the mesh network 1200 may include three APs, (e.g., an AP1 1205, an AP2 1206, and a third AP (AP3) 1207), and a plurality of electronic devices, for example, an air conditioner 1210, a computer 1220, a refrigerator 1240, and a display device 1230, may be arranged in the house.

The plurality of electronic devices in the house (e.g., the air conditioner 1210, the computer 1220, the refrigerator 1240, and the display device 1230) may be connected to at least one of the plurality of APs forming the mesh network 1200 (e.g., the AP1 1205, the AP2 1206, and the AP3 1207). Each of the plurality of electronic devices in the house may change an accessed AP according to an AP transition method according to an embodiment, considering a communication state of the accessed AP.

For example, the display device 1230 in a suspend mode may access the AP3 1207. When a communication state of the AP3 1207 is not good (e.g., signal quality is below a predetermined threshold, when a load of the AP3 1207 is high, and/or a low throughput is expected for the AP3 1207), the display device 1230 may change an accessed AP to another AP (e.g., the AP2 1206), based on a BTM request signal received from the AP3 1207.

In an embodiment, the mesh network 1200 may be used to implement an IoT environment.

A technology for using and/or controlling the plurality of electronic devices by connecting the plurality of electronic devices to a wireless communication network may have been developed such that the plurality of electronic devices may be controllable by a technology, such as an IoT platform. In an embodiment, the wireless communication network used to implement the IoT platform may include the mesh network 1200 described above.

In an embodiment, IoT may indicate that all things (e.g., electronic devices), such as a display device (e.g., a TV), a smart phone, a PC, a vehicle, a refrigerator, a washing machine, and a watch, may be connected to a wireless network. In this manner, the plurality of electronic devices may be able to exchange data, process data, and/or be automatically driven by using IoT. For example, the user may adjust the display device 1230 in the house by using a smart phone outside the house.

To implement the IoT environment, the plurality of electronic devices, for example, the smart phone of the user located at a remote place from the house and the display device 1230 located inside the house of the user, may need to maintain a communicable state.

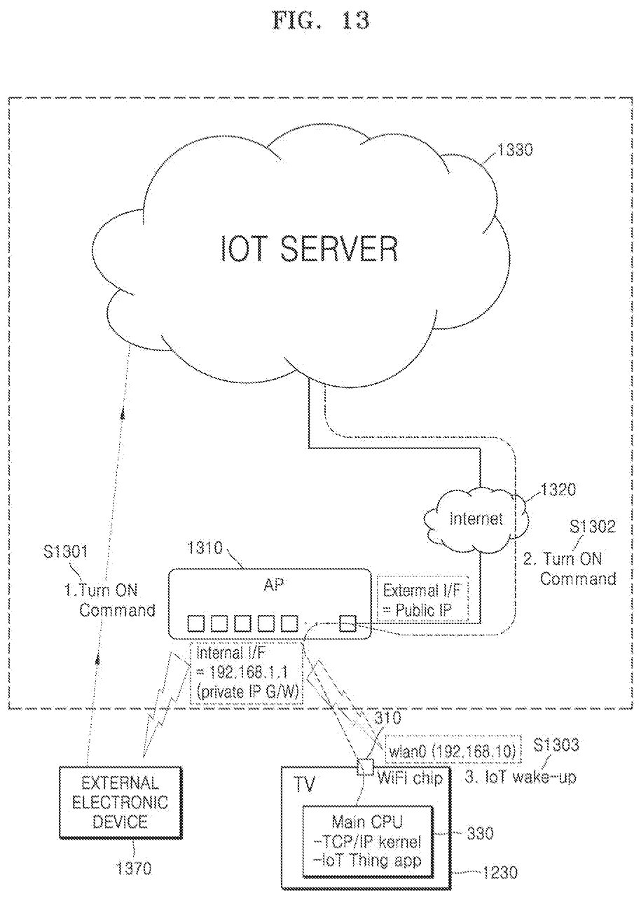

To implement the IoT environment even in the suspend mode, the electronic device, according to an embodiment, may need to maintain an access to an IoT server through the Wi-Fi network. An example in which an electronic device according to an embodiment is the display device 1230 is described with reference to FIG. 13.

FIG. 13 is a diagram describing an electronic device which operates in an IoT environment, according to an embodiment. In FIG. 13, components that are same as those in FIGS. 3B and 12 are illustrated using same reference numerals. Thus, overlapping details thereof are omitted.

In FIG. 13, an AP 1310 may be any one of the plurality of APs 1205, 1206, and 1207 located in the mesh network 1200 described in FIG. 12. Alternatively or additionally, the AP 1310 may be an AP changed when the AP transition according to an embodiment described with reference to FIGS. 1 to 11 is performed. In other words, the AP 1310 may correspond to the AP2 602 described in FIGS. 8 and 10.

In an embodiment, the display device 1230 may maintain access to an IoT server regardless of a working state. For example, the display device 1230 may maintain a connected state with an AP and maintain an access to the IoT server through the AP, even in a suspend mode or LPM of outputting a block screen. In this case, the display device 1230 may perform the AP transition so as to maintain high signal quality of an accessed Wi-Fi network. Accordingly, the display device 1230 may maintain a state of being connected to the Wi-Fi network having high signal quality, regardless of the working state, and thus may seamlessly communicate with the IoT server.

Referring to FIG. 13, the display device 1230 and an external electronic device 1370 may be connected to each other through a home IoT platform. In an embodiment, the display device 1230 and the external electronic device 1370 may be connected to each other through a wireless communication network such as an Internet network. For example, the display device 1230 and the external electronic device 1370 may be connected to each other through an IoT cloud and the AP 1310 forming an IoT platform. In an embodiment, the display device 1230 may be located in a space (e.g., inside a house) implementing an IoT environment. Alternatively or additionally, the external electronic device 1370 is a device for controlling the display device 1230 by using the IoT platform, and may be an electronic device located at a remote place from the space (e.g., inside a house) implementing the IoT environment. For example, the external electronic device 1370 may be a mobile device of a user.

An IoT server 1330 may denote a server, cloud server, or cloud server device that is connected to a plurality of electronic devices located at a long distance so as to support the IoT platform. For example, the IoT server 1330 may include a computing device operating to provide a platform or service according to IoT by supporting a communication connection between a plurality of electronic devices through a network, and may be implemented as software and/or hardware.

The display device 1230 may perform various operations according to control by the external electronic device 1370, and/or the display device 1230 may perform required operations according to control by the external electronic device 1370. As described above, the user may be located at a long distance from a space where the display device 1230 is located.

Hereinafter, an example in which a control signal received by the display device 1230 implementing the IoT platform from the external electronic device 1370 is a turn-on signal is described.

For example, the user may want a program recording operation to be performed by turning on the display device 1230 located inside a house by using the external electronic device 1370 carried by the user. In this case, the external electronic device 1370 may transmit, to the display device 1230, a signal requesting the display device 1230 to be turned on, in response to a user input. In FIG. 13, for convenience of illustration, an AP accessed by the external electronic device 1370 accesses may not be shown. In general, when the external electronic device 1370 is spaced apart from the display device 1230, the AP accessed by the external electronic device 1370 and the AP 1310 accessed by the display device 1230 may be different from each other. Alternatively or additionally, when the external electronic device 1370 and the display device 1230 are located in a same space (e.g., a space corresponding to a same BSS), the AP accessed by the external electronic device 1370 and the AP 1310 accessed by the display device 1230 may be the same.

In an embodiment, the AP 1310 may function as a bridge connecting the Wi-Fi network (e.g., a WLAN) to which the display device 1230 is connected and a mobile communication network connected to the IoT server 1330 to each other. Alternatively or additionally, in FIG. 13, to implement the IoT platform, an example in which the Internet 1320 (e.g., a network using a transmission control protocol (TCP)/Internet protocol (IP) communication protocol or an Internet protocol) is used is illustrated and described.

In an embodiment, the processor 330 included in the display device 1230 may include an IoT application and a TCP/IP kernel. In an embodiment, the IoT application may include an application enabling the IoT platform to be implemented and/or may control operations performed through the IoT platform. The TCP/IP kernel may control transmission/reception of data based on TCP/IP communication protocol (e.g., an Internet protocol). Hereinafter, for convenience of description, the TCP/IP communication protocol may be referred to as a TCP/IP protocol.

Hereinafter, an operation of remotely turning on the display device 1230 by using the IoT platform after the display device 1230 is turned off and enters a suspend mode is described.

To remotely turn on the display device 1230, the external electronic device 1370 may transmit, to the IoT server 1330 through an AP, a command requesting the display device 1230 to be turned on (operation S1301).

The Wi-Fi module 310 may receive, from the IoT server 1330, a packet corresponding to the command requesting the turn-on (operation S1302). For example, the IoT server 1330 may generate a control signal for turning on the display device 1230, based on the command received in operation S1301, and control a packet corresponding to the generated control signal to be transmitted to the display device 1230 through the AP 1310. Accordingly, the Wi-Fi module 310 of the display device 1230 may receive the packet corresponding to the control signal. Alternatively or additionally, the Wi-Fi module 310 may generate a wake-up pulse for waking the processor 330 up, based on the received packet, and control the display device 1230 to enter the LPM.

In an embodiment, for the display device 1230 to normally receive a signal transmitted from the external electronic device 1370, the display device 1230 and the external electronic device 1370 may need to maintain a communication connection. For example, the display device 1230 may need to maintain a communication connection with the external electronic device 1370 even when the display device 1230 is turned off and/or enters the suspend mode. When communication quality of the AP 1310 deteriorates, the display device 1230 may not be able to normally receive the signal transmitted from the external electronic device 1370.

Thus, according to an embodiment, an accessed AP may be transitioned even when the display device 1230 is in a suspended state, such that the display device 1230 and the external electronic device 1370 may seamlessly communicate with each other. Accordingly, the Wi-Fi module 310 of the display device 1230 transitions to and accesses an AP having high communication quality, and thus the control signal corresponding to the turn-on command may be seamlessly received from the AP 1310. Thus, the display device 1230 may wake up quickly and accurately based on the received control signal (operation S1303).

As described with reference to FIGS. 12 and 13, when an electronic device according to an embodiment accesses a Wi-Fi network by an IoT platform, AP transition for maintaining high communication quality may be performed even when the electronic device is in a suspend mode, and thus the high communication quality may be maintained. Accordingly, the electronic device may implement an IoT environment with a high degree of reliability.

An operating method of an electronic device, according to an embodiment, may be recorded on a computer-readable recording medium by being implemented in a form of program commands executed by using various computers. Further, an embodiment may include a computer-readable recording medium having recorded thereon one or more programs including instructions for executing an operating method of an electronic device, according to an embodiment.

The computer-readable recording medium may include at least one of a program command, a data file, or a data structure. The program commands recorded in the computer-readable recording medium may be specially designed or well known to one of ordinary skill in the computer software field. Examples of the computer-readable recording medium include magnetic media such as hard disks, floppy disks, and magnetic tapes, optical media such as compact disc read-only memory (CD-ROM) and digital versatile disc (DVDs), magneto-optical media such as floptical disks, and hardware devices specially configured to store and perform program commands, such as ROM, RAM, and flash memory. Examples of the computer command include machine codes generated by a compiler, and high-level language codes executable by a computer by using an interpreter.

A machine-readable storage medium may be provided in the form of a non-transitory storage medium. The “non-transitory storage medium” may only denote a tangible device and may not contain a signal (e.g., electromagnetic waves). This term may not distinguish a case where data is stored in the storage medium semi-permanently and a case where the data is stored in the storage medium temporarily. For example, the “non-transitory storage medium” may include a buffer where data is temporarily stored.

Furthermore, an operating method of an electronic device, according to an embodiment, may be provided by being included in a computer program product. The computer program products may include products that may be traded between sellers and buyers. The computer program product may be distributed in the form of machine-readable storage medium (e.g., a CD-ROM), or distributed (e.g., downloaded or uploaded) through an application store (e.g., Play Store™) or directly or online between two user devices (e.g., smart phones). In the case of online distribution, at least a part of the computer program product (e.g., a downloadable application) may be at least temporarily generated or temporarily stored in a machine-readable storage medium, such as a server of a manufacturer, a server of an application store, or a memory of a relay server.

That is, the computer program product may include a recording medium storing a program for executing an operating method of an electronic device, according to an embodiment.

While the embodiments of the present disclosure have been particularly shown and described in detail, it is to be understood by one of ordinary skill in the art that various changes in form and details may be made therein without departing from the spirit and scope of the present disclosure as defined by the following claims.

1. An electronic device, comprising:
a Wi-Fi module comprising an internal memory; and
a processor configured to execute at least one instruction,
wherein the Wi-Fi module is configured to:
store, in the internal memory, a first request requesting an access point transition;
generate a wakeup signal, based on reception of the first request from a first access point, while the processor is in a suspend mode; and
transmit, to the processor, the first request stored in the internal memory, after the processor has woken up based on the wakeup signal.

2. The electronic device of claim 1, wherein the processor is further configured to execute the at least one instruction to control the Wi-Fi module to transmit, to the first access point, a first response, based on the first request.

3. The electronic device of claim 1, further comprising:
a microcomputer configured to:
receive the wakeup signal transmitted from the Wi-Fi module; and
transmit a power-on signal to the processor, based on the wakeup signal,
wherein the processor is further configured to execute the at least one instruction to wake up based on reception of the power-on signal.

4. The electronic device of claim 1, wherein the first request comprises a basic service set (BSS) transition management (BTM) request.

5. The electronic device of claim 1, wherein the Wi-Fi module is further configured to:
identify whether the processor has woken up when a predetermined time duration has elapsed after transmission of the wakeup signal; and
transmit, to the processor, the first request stored in the internal memory, based on a result of the identifying that the processor has woken up.

6. The electronic device of claim 1, wherein the Wi-Fi module is further configured to transmit, to the processor, the first request stored in the internal memory, based on reception of an up signal indicating that the processor has woken up.

7. The electronic device of claim 2, wherein the processor is further configured to execute the at least one instruction to control an access point, accessed by the Wi-Fi module, to transition from the first access point to a second access point, when the first response is transmitted to the first access point.

8. The electronic device of claim 7, wherein the processor is further configured to execute the at least one instruction to enter the suspend mode when the transition of the access point has been completed.

9. The electronic device of claim 8, wherein to enter the suspend mode comprises to:
transmit, to the Wi-Fi module, a command instructing to maintain a connection with the second access point; and
transmit, to the Wi-Fi module, a notification indicating entry to the suspend mode, based on the transition of the access point having been completed.

10. The electronic device of claim 1, wherein the Wi-Fi module is further configured to maintain access to an Internet of Things (IoT) server while the processor is in the suspend mode.

11. The electronic device of claim 1, further including a wireless client device connected with a mesh network formed by a plurality of access points.

12. An operating method of an electronic device, the operating method comprising:
receiving, from a first access point, a first request requesting an access point transition, while the electronic device is in a suspend mode;
storing the first request in an internal memory;
generating a wakeup signal; and
transmitting, to a processor of the electronic device, the first request stored in the internal memory after the processor has woken up based on the wakeup signal.

13. The operating method of claim 12, further comprising:
transmitting, to the first access point, a first response, based on the first request.

14. The operating method of claim 12, wherein the transmitting of the first request comprises:
identifying whether the processor has woken up when a predetermined time duration has elapsed after the wakeup signal has been transmitted; and
transmitting, to the processor, the first request stored in the internal memory, based on a result of the identifying.

15. The operating method of claim 13, further comprising:
controlling an access point to transition from the first access point to a second access point, when the first response has been transmitted to the first access point.

16. The operating method of claim 12, wherein the first request comprises a basic service set (BSS) transition management (BTM) request.

17. The operating method of claim 12, a microcomputer is comprised in the electronic device, and
the method further comprising, by the microcomputer, receiving the wakeup signal, and transmitting a power-on signal to the processor, based on the wakeup signal; and
the processor is wakening up based on reception of the power-on signal.

18. The operating method of claim 15, further comprising:
by the processor, transmitting a command instructing to maintain a connection with the second access point and a notification indicating entry to the suspend mode, based on the transition of the access point having been completed; and
entering the suspend mode.
